(19) United States
(12) Patent Application Publication
(10) Pub. No.: US 2026/0157380 A1
(43) Pub. Date: Jun. 11, 2026

(54) READY-MADE BATTER IN AN AEROSOL CAN

(71) Applicant: OBSHCHESTVO S OGRANICHENNOI OTVETSTVENNOSTIU "AVANGARD INNOVATCII", SAINT-PETERSBURG (RU)

(72) Inventors: Igor Igorevich NESTEROVICH, SAINT-PETERSBURG (RU); Viktoriia Maksimovna NESTEROVICH, SAINT-PETERSBURG (RU); Iurii Aleksandrovich SHARGALIN, SAINT-PETERSBURG (RU)

(21) Appl. No.: 18/724,201

(22) PCT Filed: Nov. 27, 2022
(86) PCT No.: PCT/RU2022/050372

§ 371 Date: Jun. 26, 2024

(30) Foreign Application Priority Data
Dec. 30, 2021 (RU) 2021140074

(51) Int. Cl. A21D 10/04; A21D 2/16; B65D 83/141

(52) U.S. Cl. CPC A21D 10/045; A21D 2/165; B65D 83/141

(57) ABSTRACT

Ready-made batter in an aerosol can provides for maintaining stable organoleptic and rheological properties of the ready-made batter (semi-finished product) for 1 to 3 months of storage and use of the semi-finished product, including a week after the first use until empty. The formula ensures permanence and homogeneity of the specified consistency and texture of the ready-made batter (semi-finished product) to provide stable and uniform discharge from the can during the entire storage life, as well as maintaining all specified properties of the dough (semi-finished product) in an aerosol can under conditions of fermentation, oxidative spoilage and microbial damage.

The invention relates to the food industry, in particular to the production of semi-finished dough products, and is intended to significantly extend the dough storage life and maintain its consumer properties during storage and use for the preparation of finished products.

It is common knowledge that dough is a semi-finished product used in bread, pastry, and pasta making. It is also commonly known that in the general case a dough recipe contains different ingredients that stimulate biochemical and microbiological reactions, including fermentation, which can be stopped by lowering the storage temperature. It is known that in order to make pastry with better quality, the significant part of the dough is prepared with yeast which excludes adding of preservatives to extend its storage life due to their mutual influence.

This results in general conditions and requirements for packaging of the ready-made batter for its storage and usage, which are established at the prior art of food technologies. These requirements include low temperature conditions, a short storage life (1 to 3 days), and the demand to release the gas-air mixture, which is formed during biochemical and microbiological reactions. The methods known at the prior art of food technologies for packaging and mid-term storage of frozen dough are generally not convenient due to the obvious necessity to unfreeze it. Thus in the authors'opinion, the prior art of food technologies does not provide for the high consumer properties of ready-made batter packaging because:
it is technologically inconsistent with properties of package reliability and integrity as it requires to provide for venting which results in break of package's airtightness;
it economically hampers planning of production and sales of ready-made batter for mid-term (1 to 3 months) due to the impossibility to store it for more than several days;
it does not provide for high marketing metrics with regard to attractiveness for consumer appeal;
in general, it does not allow for an ergonomically efficient level of convenience during storage and use.

In patent literature, a number of technical solutions are well known in the prior art:

US20110177214 of 2011 discloses a packaged dough product, wherein the package contains an outer layer of plastic heat-shrink film, a container, in which the inner pressure is 15 pounds per square inch. The dough in the container is a chemically stable aerated dough inside the package. The application discloses a great number of devices for excess pressure discharge and compensation of dough expansion, including the use of self-expanding packaging. The main arrangement which provides for the extension of storage life (apart from cooling) is a preliminary package space reservation or pressure drop for the further gradual filling with expanding dough as a result of biochemical reactions.

This solution including all its embodiments disclosed in the application is straightforward and does not provide for the mid-term storage of ready-made batter for a period from 1 to 3 months.

US20190246652 of 2019 discloses a method for packing and storage of dough in pressurized packs allowing the product to expand inside an interior volume of the package under pressure and be stored under refrigerated conditions for more than four weeks. The method includes the design of a self-sealed cylindrical tube package with a spiral wound element, which envisages an additional volume to compensate for the dough self-expanding. The method for preparing a packaged product includes placing of the dough containing pectin inside the package, sealing, and storing the dough which self-expands due to the action of carbon dioxide as a result of a chemical reaction caused by the dough leavening system.

This solution is not free from the disadvantages of the previous invention, the main of which is the non-ergonomic character of the package when in use, as the first usage breaks the factory tightness of the package and significantly reduces the period of its re-usage.

US20210267219 of 2021 discloses a method of producing dough for pizza, pancakes, etc., which comprises a step of dough producing providing for its increased fluidity and viscosity, inserting the resulting dough into a squeezable package, sealing up, and refrigerating. The applicant obtains increased fluidity and viscosity by varying yeast content in the total volume of the dough, and also discloses several embodiments of the package. The main concept of the invention consists in the dough fluidity index, which is similar to that of a standard toothpaste, allowing its use in soft sealed pouches when making pizza, crepes, and other products.

This solution seems more ergonomic than the previous ones; nonetheless it is insufficient as the soft plastic package is not convenient, and the air-tightness of the dough storage is broken after just the first use.

As a prototype, the authors chose the closest solution of U.S. Pat. No. 8,147,893 of 2007, which discloses a method of preparing a batter for a bakable food product that comprises selecting of ingredients, including flour, sugar, and egg powder, their blending with adding water no less than 40.5% by weight and no greater than 52.5% by weight of the batter, wherein the batter has a viscosity between approximately 12000 cP and approximately 14000 cP, pH≈6, and water activity of ≈0.96. After preparation, the batter is put into an air-tight package (dispenser or pressurized can, which is similar to the aerosol can in terms of the present application) and sealed using carbon dioxide CO₂ to develop pressure in the pressurized can and also as a preserving agent.

Technical solution according to patent U.S. Pat. No. 8,147,893 describes a method of preparing and storing the batter and shows pressure change charts for a pressurized dispenser, but it does not disclose the procedure for ensuring the quality and consumer properties of the batter stored in the pressurized dispenser during a mid-term period of 1 to 3 months. As a disadvantage, the authors note that emulsification of the batter is achieved only through the pressure of MA (Modified Atmosphere) in the pressurized dispenser; the Modified Atmosphere consisting of 10% to 20% carbon dioxide (CO₂), while the batter is more viscose.

In order to solve the aforementioned problems of the prior art related to the storage of ready-made batter, the authors focused on providing for the consumer properties of the ready-made batter during its storage and use, which correspond to:
mid-term storage period of 1 to 3 months under refrigerated conditions in stores and households;
high ergonomic and aesthetic properties when being applied for making finished products during a week after the first use until empty.

The authors solve the problem using an aerosol can to package ready-made batter for the period of its storage and application. The applicant has successfully introduced for civil use this type of the ready-made batter package https://blinochkin.ru/ and provided for maintaining its consumer properties (value and good quality) for the entire claimed period of storage and use. Meanwhile, the authors'recipe provides for dough preparation first as an emulsion (stable homogeneous or dispersed mass) opposed to the recipe from U.S. Pat. No. 8,147,893, wherein the authors ensure emulsification by the action of pressure and the MA content, specifically carbon dioxide. The U.S. Pat. No. 8,147,893 applicant also tried to introduce into civil circulation in the USA a dough in aerosol cans. The attempt was unsuccessful because it did not provide for adequate organoleptic characteristics of dough, particularly concerning excessive sour flavor (acidity of the product).

The choice of an aerosol can as a package for storage and use of the ready-made batter contributes to ensuring the consumer properties (value and good quality) of the ready-made batter established by standards (TU) under refrigerated conditions and pressure of 2 to 12 atmospheres of MA, which contains not more than 12%, by volume, of oxygen and at least 50% propellant (GOST R52499-2005). Nevertheless, such a choice in itself is not sufficient to ensure the claimed storage period of 1 to 3 months and demands solving a number of tasks to provide for the following:
specified acidity indexes for a neutral and/or slightly sour flavor of the ready-made batter;
maintaining stable organoleptic and rheological properties of the ready-made batter (semi-finished product), during the entire storage life and use of the semi-finished product for 1 to 3 months, including a week after the first use until empty;
permanence and homogeneity of the specified consistency and texture of the ready-made batter (semi-finished product) to provide stable and uniform discharge from the aerosol can during the entire storage life and use for 1 to 3 months, including a week after the first use until empty;
sufficient water activity index for normal discharge from the aerosol can under condition that the required quality of the dough (organoleptic and rheological properties, microbiological safety) is maintained during the claimed period of storage and use;
maintaining all specified properties of the dough (semi-finished product) for 1 to 3 months, including a week after the first use until empty, in an aerosol can under conditions of fermentation, oxidative and bacteriological spoilage.

Moreover, all the above-specified qualitative features must be ensured under the conditions of their mutual influence on consumer properties. In particular case, this problem is solved through the use of technologies and recipes, the complete composition of which is protected by the applicant as a trade secret. In general case, ensuring of the above-specified properties demands preliminary (before putting into an aerosol can) preparation without yeast and emulsion texture of the dough which is suitable for storage and use in the aerosol can during the claimed storage and use period.

The technological problem of the invention and its technical result consist in maintaining of consumer properties of the ready-made batter during the period of 1 to 3 months for its storage and use in an aerosol can under refrigerated conditions. Another technological problem of the invention is the extension of the storage life of ready-made batter in an aerosol can up to 6 months in frozen condition.

The said technical result is achieved through the ready-made batter in an aerosol can stored in a modified atmosphere that consists of at least 50% of the propellant and not more than 12% of oxygen at a pressure of 2-12 atmospheres, which has a water activity index of more than 0.725 and less than 0.985 and fat content of at least 1%, wherein the ready-made batter is made in the form of an emulsion representing a stable homogeneous or dispersed mass with a microbial contamination index (QMA&OAMO) of not more than 1*10⁶ CFU/g, contains vegetable oil with a high content of non-saturated OMEGA-9 fatty acids in the form of refined, deodorized oil made from olives, canola or sunflower seeds or a product with a high content thereof and at least one food additive in the form of a preservative, antioxidant, consistency stabilizer, emulsifier, emulsifying salt, thickening agent, acidity regulator or sugar, intended to protect the product against bacteriological and oxidative spoilage and extend its storage life.

Traditionally, emulsion is used in the food industry as a component of a formula for dough making. The distinction of the method claimed by the authors is that the emulsion structure is used to provide for optimal consistency and texture of the ready-made batter for its storage and use in an aerosol can during the claimed period of 1 to 3 months.

Commercial preparation of dough with emulsion structure and optimal consistency for storage and use in aerosol cans includes standard operations of raw material (ingredients) dosing: flour, water of the specified temperature, food additives, sugar, vegetable oil.

The authors achieve elimination of excess acid flavor as per U.S. Pat. No. 8,147,893 in the ready-made batter through the development of a more complicated own formula with minimal addition of acidity regulators with low hydrogen value. Moreover, other ingredients with lower QMA&OAMO value and preservatives minimize risks of acid formation in the product during storage. The applicant protects the detailed characteristics of his own formula as a trade secret.

The microbial contamination index (QMA&OAMO) of the ready-made batter is set within the limits of not more than 1*10⁶ CFU/g, by means of selecting raw materials including flour, sugar, starch, and gluten, each of them having this index NMT 1*10⁴ CFU/g, and using preservatives. In order to inhibit the excessive growth of microorganisms that worsen the organoleptic properties of the finished product baked from the dough in an aerosol can, the growth being controlled by the total microbial count (QMA&OAMO) within not more than 1*10⁶ CFU/g, food additives and/or formulation components are introduced into the dough formulation. In one embodiment, it is sorbic acid and its salts (GOST R54956-2012). In another embodiment, it is propionic acid and its salts (GOST R54956-2012). In yet another embodiment of the method, the amount of sugars in the formula is increased by more than 16% and vegetable oils by more than 8% of the total weight.

The ready-made batter is prepared in the form of an emulsion (stable homogeneous or dispersed mass) with a total fat content of not less than 1%. Which is provided with fats contained in raw materials and/or with the addition of vegetable or animal fats. Emulsification is provided by adding food additives—emulsifiers according to GOST 32770-2014, or in various embodiments, natural emulsifiers in the form of vegetable and/or animal proteins, including those contained in raw materials. To improve the emulsion stability, stabilizers are used. Dietary fibers or standard stabilizers according to GOST 33782-2016, as well as others known in the prior art of food technology, are used as stabilizers. To ensure the specified structure of the ready-made batter, thickening agents according to GOST 33310-2015 may be used. In one embodiment of the invention, carboxymethyl cellulose E 466 in a dose of 0.01 to 0.15%, sodium alginate E 401 in a dose of 0.1 to 0.5% of the total weight may be introduced into the formula. Stable homogeneous or dispersed mass of the ready-made batter is provided by the usage of standard production equipment: milling mixers and high-speed mixers, homogenizers, and dispersers.

The water activity index 0.725 to 0.985 of the ready-made batter is ensured by introduction into the formula of different cryoprotectors (salt, sugar) and stabilizers according to GOST 33782-2016. The lower boundary of the index is achieved by the introduction of starch syrup and food-grade glycerol into the formula. The upper boundary is achieved by adding stabilizers in amount of 0.4 to 1% of the semi-finished product weight.

To ensure the claimed mid-term storage period of 1 to 3 months, the formula of the ready-made batter includes at least one food additive (GOST R52499-2005), intended to protect the ready-made batter against bacteriological and oxidative spoilage and extend its storage life. The type of food additives including those specified in GOST R54956-2012, GOST R53045-2008, GOST R55517-2013 is equivalent to the preservatives known in the prior art of food technologies, substances which decrease the microbial activity of microorganisms and the fat oxidation process accordingly.

To prevent oxidation processes, oil with a high content of unsaturated fatty acids of the OMEGA 9 group, among them high-purity and high-oleic vegetable oil, is used. The authors found the formula with oil by experiment and chose it because of the high natural resistance of high-oleic oil to oxidation processes compared to vegetable oils with low-oleic acid content, which provides for the claimed period of storage and use in an aerosol can. As a source of the OMEGA 9 unsaturated acids, vegetable oils made from olives, canola or sunflower seeds or other products with a high content thereof may be introduced into the formula. Wherein the oleic acid content in oil meets the requirements of GOST 30623-98 for high-oleic oil. As products with a high content of unsaturated fatty acids of the OMEGA 9 group, oils made from nuts, oilseeds, cereals, and other vegetable oils may be used in the dough formula.

In addition, antioxidants can be included in the formula in order to prevent oxidation processes. In one embodiment, it can be ascorbic acid E300 or its salts (natrium ascorbat E301, calcium ascorbate E302, potassium ascorbate E303), in amount of 0.1 to 2% individually or in combination equivalent to ascorbic acid. In another embodiment, butylated hydroxyanisole E320 can be included in the formula in an amount of 0.01 to 0.02%. Additionally, the claimed storage period is ensured through selection of raw materials with the specified indexes of purity and manufacturing cleanness.

Then the ingredients in the dough-mixing machine are mixed until the emulsion consistency and texture of dough is reached. Packaging of the dough into aerosol cans is performed following the standard procedure known from the prior art of food technologies, in general, including placing the prepared dough in a can, sealing it and pumping a “supporting” pressure of 2 to 12 atmospheres MA, which includes at least 50% propellant and not more than 12% oxygen.

The dough in an aerosol can, prepared and packed through the above-described method, is stored at a refrigerated temperature for 1 to 3 months, and under freezing conditions for up to 6 months. The emulsion structure and consistency are well suited to the principle of discharge arrangement for the content of the aerosol can, which involves parameters of air-tightness and “supporting” pressure injected into the can. At the same time, in different embodiments without limitations to the scope of protection of the claimed product, the ready-made batter in the aerosol can may be isolated from the injected gas through its placing into a soft isolated bag with different microclimate parameters inside the bag.

Usage of dough in an aerosol can involves a standard discharge of the ready-made batter (emulsion) from an aerosol can through a nozzle (valve) by the action of the injected (supporting) pressure of MA.

The above-described technological measures, combined with the use of oil with a high content of non-saturated fatty acids of the OMEGA 9 group, at least one food additive, formulae with minimal addition of acidity regulators with a low hydrogen (pH) index ensure the constancy of the QMA&OAMO index within the limits of not more than 1*10⁶ CFU/g and protection of the ready-made batter against bacteriological and oxidative spoilage, particularly but not exclusively ensuring an acidity index for a neutral and/or slightly acid flavor of the ready-made batter. At the same time, the emulsion structure of the ready-made batter, its stability and texture in combination with the water activity index 0.725 to 0.985 provide for a stable and uniform flow of the ready-made batter out of the aerosol can while maintaining its required quality (organoleptic and rheological properties, microbiological safety) during the entire claimed period of 1 to 3 months including a week after the first use until empty.

1. Ready-made batter in an aerosol can, stored in a modified atmosphere under pressure, which has the water activity index more than 0.725 and less than 0.985, microbial contamination index (QMA&OAMO) not more than 1*10⁶ CFU/g, fat content not less than 1%, wherein the ready-made batter is made in the form of emulsion, comprises vegetable oil with high content of non-saturated fatty acids of the OMEGA 9 group or a product with their high content and at least one food additive intended to protect against bacteriological and oxidative spoilage and extend the storage life.

2. Ready-made batter in an aerosol can according to claim 1, wherein the emulsion represents a stable homogeneous or dispersed mass.

3. Ready-made batter in an aerosol can according to claim 1, wherein at least one of the food additive is a preservative, antioxidant, consistency stabilizer, emulsifier, emulsifying salt, thickening agent, acidity regulator or sugar.

4. Ready-made batter in an aerosol can according to claim 1, wherein high-oleic refined deodorized oil made from sunflower seeds is used in the formula of the ready-made batter as vegetable oil with a high content of unsaturated fatty acids of the OMEGA 9 group.
